(19) United States
(12) Patent Application Publication
(10) Pub. No.: US 2026/0194385 A1
(43) Pub. Date: Jul. 9, 2026

(54) IMMERSION DETECTION SYSTEM, IMMERSION DETECTION DEVICE AND IMMERSION DETECTION METHOD

(71) Applicant: NTT, Inc., Tokyo (JP)

(72) Inventors: Tomohiro Kawano, Musashino-shi, Tokyo (JP); Akihiro KURODA, Musashino-shi, Tokyo (JP); Hiroshi WATANABE, Musashino-shi, Tokyo (JP); Kuniaki Terakawa, Musashino-shi, Tokyo (JP); Kazunori Katayama, Musashino-shi, Tokyo (JP)

(21) Appl. No.: 19/130,646

(22) PCT Filed: Dec. 15, 2022
(86) PCT No.: PCT/JP2022/046245

§ 371 Date: May 16, 2025

(51) Int. Cl. G01F 23/292; G08B 21/20; G08C 23/06

(52) U.S. Cl. CPC G01F 23/2928; G08C 23/06; G08B 21/20

(57) ABSTRACT

A water flood detection system includes a control device 1 and a water flood detection device 2, wherein the control device 1 includes a light source 11 that outputs light to the water flood detection device 2 via an optical fiber 4, wherein the water flood detection device 2 includes: a photoelectric conversion unit 21 configured to convert the light into electricity; a power storage unit 24 configured to store the converted electricity; and a water flood detection sensor 31 that operates using electricity from the power storage unit 24 to detect water flooding in an underground facility.

### TECHNICAL FIELD

The present disclosure relates to a water flood detection system, a water flood detection device, and a water flood detection method.

### BACKGROUND ART

In optical fiber networks, particularly in access networks connecting telecommunications carriers and optical terminals, if optical fiber connections are submerged in water for a long period of time, optical loss increases and mechanical strength decreases, resulting in failures. Therefore, an optical fiber core wire (maintenance core wire) separated from that used for communication is installed at a connection located in an underground facility such as a manhole, and a water flood detection module is installed that gives a bending loss when the maintenance core wire is submerged in water. The maintenance core wire is periodically tested with an optical time domain reflectometer (OTDR) to monitor whether each connection is submerged in water.

NPL 1 proposes a system in which, when water enters an optical fiber, an expandable material expands to bend the optical fiber (create bends), adding bending loss, which is detected by the OTDR test. Further, by optimizing bends and providing water entry detection points in multiple locations, it is possible to more accurately analyze for the water entry points. PTL 1 describes an optical node that is optically powered via an optical fiber.

### CITATION LIST

### Patent Literature

[PTL 1]WO2022/102103

### Non Patent Literature

[NPL 1]Kenichi Nakazawa, Tsunekazu Watanabe, Yoshitaka Enomoto, Wataru Kuratani, Hisashi Fujimoto, “Improvement Water Sensor Module for Detecting Water in Cable Joints”, IEICE Technical Report, vol. 109, No. 303, OFT2009-60, pp. 35-39, November 2009

### SUMMARY OF INVENTION

### Technical Problem

However, the system described in NPL 1 is premised on detection of water flooding within closures, and is therefore unable to detect water flooding within an underground facility such as a manhole in which a closure is located. Accordingly, it is not possible to take pre-emptive measures that can be taken before the closure is flooded, such as draining the underground manhole.

Furthermore, once the expandable material has expanded, it does not return to its original shape, so it is not possible to repeatedly detect water flooding in NPL 1.

The present disclosure has been made in consideration of the circumstances described above, and an object of the present disclosure is to provide a technology that can repeatedly detect water flooding in an underground facility.

### Solution to Problem

To achieve the object, an aspect of the present disclosure is a water flood detection system including a control device and a water flood detection device, wherein the control device includes a light source that outputs light to the water flood detection device via an optical fiber, wherein the water flood detection device includes: a photoelectric conversion unit configured to convert the light into electricity; a power storage unit configured to store the converted electricity; and a water flood detection sensor that operates using electricity from the power storage unit to detect water flooding in an underground facility.

An aspect of the present disclosure is a water flood detection device, including: a photoelectric conversion unit configured to convert light into electricity, the light being output from a control device via an optical fiber; a power storage unit configured to store the converted electricity; and a water flood detection sensor that operates using electricity from the power storage unit to detect water flooding in an underground facility.

An aspect of the present disclosure is a water flood detection method executed by a control device and a water flood detection device, wherein the control device outputs light to the water flood detection device via an optical fiber, and the water flood detection device converts the light into electricity, stores the converted electricity, and operates using the stored electricity to detect water flooding in an underground facility.

### Advantageous Effects of Invention

According to the present disclosure, it is possible to provide a technology that can repeatedly detect water flooding in an underground facility.

### BRIEF DESCRIPTION OF DRAWINGS

FIG. 1 is a diagram illustrating a configuration of a water flood detection system according to Embodiment 1.

FIG. 2 is a diagram illustrating an installation location of a water flood detection device.

FIG. 3 is a diagram illustrating a configuration of a water flood detection module.

FIG. 4 is a flowchart illustrating operations of the water flood detection system.

FIG. 5 is a diagram illustrating a configuration of a water flood detection system according to Embodiment 2.

### DESCRIPTION OF EMBODIMENTS

Embodiments of the present disclosure will be described with reference to the accompanying drawings. The embodiments described below are examples of the present disclosure, and the present disclosure is not limited to the following embodiments. It is assumed that components with the same reference numerals in the present specification and the drawings represent the same components.

### Embodiment 1

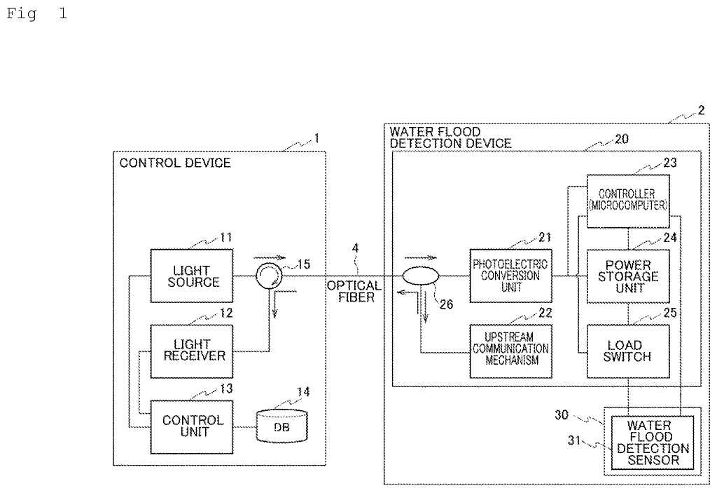

FIG. 1 is a diagram illustrating a configuration of a water flood detection system according to the present embodiment.

The water flood detection system shown in the drawing includes a control device 1 and a water flood detection device 2 (optical node). The upstream control device 1 and the downstream water flood detection device 2 are connected via an optical fiber 4. In the present embodiment, a direction from the water flood detection device 2 to the control device 1 will be described as the “upstream direction,” and a direction from the control device 1 to the water flood detection device 2 will be described as the “downstream direction.”

The control device 1 is installed in an environment where power is available (for example, in a communication carrier building) and supplies power via the optical fiber. Specifically, the control device 1 outputs light for power supply to the water flood detection device 2 via the optical fiber 4. The control device 1 shown in the drawing includes a light source 11 that outputs light, an optical receiver 12, a control unit 13, a database 14, and an optical circulator 15. The light will also be referred to as an optical signal in the following explanation.

The optical circulator 15 performs branching into a downstream optical signal and an upstream optical signal. The downstream optical signal and the upstream optical signal are branched off through the optical circulator 15, and the single optical fiber 4 can connect the control device 1 and the water flood detection device 2.

The light source 11 is composed of, for example, an internally modulated laser with a modulation function, and is able to superimpose a control signal to the water flood detection device 2 on the light for power supply. Laser light emitted from the light source 11 is input to the optical fiber 4 via the optical circulator 15. A wavelength of the laser light is, for example, 1480 nm to 1490 nm. The power of the laser light output from the light source 11 is approximately +10 to 17 dBm.

The optical receiver 12 receives the optical signal output from the water flood detection device 2 via the optical fiber 4, converts it into an electrical signal, and outputs it to the control unit 13. The optical signal includes, for example, detection information detected by the water flood detection device 2. The optical receiver 12 adopts a light receiving element such as a photodiode.

The control unit 13 executes various types of control. For example, the control unit 13 sends a modulated signal to the light source 11 and superimposes the control signal to the water flood detection device 2 on the light for power supply output by the light source 11. The control signal includes, for example, a water flood detection instruction, a power supply instruction to initiate or stop power supply, and an inquiry about the amount of stored power in a power storage unit 24. Note that a power supply method from the control device 1 of the present embodiment for the water flood detection device 2 can be, for example, a power supply method disclosed in PTL 1.

Further, the control unit 13 stores the detection information contained in the electrical signal output from the optical receiver 12 in the database 14. The database 14 stores the detection information related to water flooding in the underground facility detected by the water flood detection device 2.

The water flood detection device 2 is connected to the control device 1 via the optical fiber 4, and is a device capable of storing electricity through optical power supply. Therefore, the water flood detection device 2 can be installed in a place without a power source. The water flood detection device 2 of the present embodiment is placed in the underground facility without a power source, and detects water flooding in the underground facility.

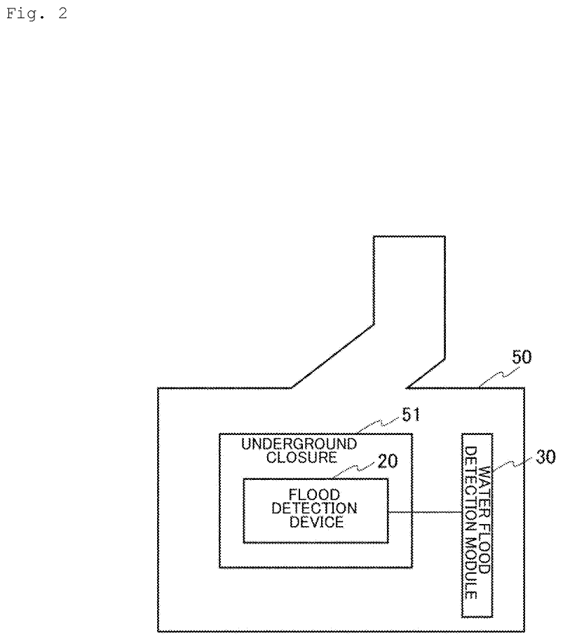

Specifically, as shown in FIG. 2 described below, a main body 20 of the water flood detection device 2 is installed in a closure (underground closure) installed in the underground facility, and the water flood detection module 30 is placed in the underground facility outside the closure. The following description assumes that the underground facility is a manhole (underground manhole).

The water flood detection system of the present embodiment is a system in which one water flood detection device 2 is connected to one control device via the optical fiber 4.

The main body 20 of the illustrated water flood detection device 2 includes an optical coupler 26, a photoelectric conversion unit 21, an upstream communication mechanism 22, a controller 23, a power storage unit 24, and a load switch 25.

The optical coupler 26 branches optical power. The optical coupler 26 is a multiplexer/demultiplexer that can multiplex/demultiplex downstream light and upstream light. The optical coupler 26 is a branching ratio coupler, and branches a greater portion of the optical power of the downstream light output from the control device 1 to the photoelectric conversion unit 21, with a branching ratio of, for example, 90:10 or 99:1.

The photoelectric conversion unit 21 converts the light outputted from the optical coupler 26 into electricity. The photoelectric conversion unit 21 adopts a photoelectric conversion element capable of receiving the wavelength of the laser light emitted by the light source 11. As the photoelectric conversion element, an element which is easily available and is suitable for a long wavelength of 1300 nm and 1600 nm band for communication, for example, an element that is formed of indium gallium arsenide and has an open circuit voltage not more than 5 V and a conversion efficiency of about 30%, can be used. A wavelength of the light emitted by the light source 11 of the control device 1 is a wavelength that corresponds to the photoelectric conversion element of the photoelectric conversion unit 21 used.

The photoelectric conversion element is, for example, an optical power supply converter. Furthermore, when a power of the laser light transmitted through the optical fiber 4 is, for example, around 2 mW, it can be used for optical power supply. The power varies depending on a device used as optical power supply.

The power storage unit 24 stores the electrical energy converted by the photoelectric conversion unit 21. The power storage unit 24 may be, for example, an electric double-layer capacitor. Further a voltage supplied to each active element can be adjusted as appropriate by a boost circuit (such as a DC/DC converter).

The light with the smaller optical power branched by the optical coupler 26 is guided to the upstream communication mechanism 22. The upstream communication mechanism 22 is equipped with a reflective optical switch (not shown) that performs modulation synchronized with a signal from the controller 23 described below. The upstream communication mechanism 22 modulates the light with the smaller optical power branched by the optical coupler 26 using the optical switch to generate modulated light. The generated modulated light is output to the control device 1 via the optical fiber 4 as an upstream optical signal to the control device 1. The modulated light includes, for example, detection information detected by the water flood detection sensor 31 and information on the voltage of the power storage unit 24.

It is desirable for the upstream communication mechanism 22 to operate at a low voltage and with very little power consumption of a few μW or less; for example, it is possible to use an electrostatically driven MEMS optical switch, which has low drive power and is generally available.

The controller 23 controls each active element such as the upstream communication mechanism 22, the load switch 25, and the water flood detection sensor 31. The controller 23 may, for example, be a microprocessor. The controller 23 mainly has four functions (1) to (4).

### (1) Downstream Frame Analysis Function

The controller 23 analyzes a downstream frame contained in the light received by the photoelectric conversion unit 21 from the control device 1. Based on control from the control unit 13, the light source 11 of the control device 1 modulates the intensity of the output laser light to generate a digitized downstream frame such as a time to live (TTL) or CMOS signal. The downstream frame includes various instructions (control signals) regarding requests to the water flood detection device 2 and switching the power supply to the water flood detection sensor 31.

### (2) Upstream Signal Generation Function

The controller 23, in cooperation with the downstream frame analysis function, modulates the optical switch provided in the upstream communication mechanism 22 to generate an upstream optical signal.

### (3) Water Flood Detection Sensor Control Function

The controller 23, in cooperation with the downstream frame analysis function and upstream signal generation function, reads instructions from the control device 1, operates the water flood detection sensor 31, and outputs detection information detected by the water flood detection sensor to the control device 1. For example, the controller 23 generates an optical signal of the detection information detected by the water flood detection sensor 31 as requested in the downstream frame using the upstream communication mechanism 22, and outputs it to the control device 1 via the optical fiber 4.

### (4) Power Monitoring Function

The controller 23 monitors the amount of stored energy in the power storage unit 24 using an AD converter (not shown) provided in the controller 23. For example, the controller 23 works, in conjunction with the downstream frame analysis function and the upstream signal generation function, to read instructions from the control device 1, acquire the voltage of the power storage unit 24, generate an optical signal of the acquired voltage value using the upstream communication mechanism 22, and output it to the control device 1 via the optical fiber 4.

As described above, the controller 23 links the above four functions together to communicate with the control device 1 while monitoring the amount of stored energy in the power storage unit 24, and also operates the water flood detection sensor 31 using power from the power storage unit 24 to obtain the detection information.

The load switch 25 is provided between the power storage unit 24 and the water flood detection sensor 31, and controls the power supply from the power storage unit 24 to the water flood detection sensor 31. Specifically, the load switch 25 performs on/off control so that power is supplied to the water flood detection sensor 31 only when necessary. The load switch 25 is operated in accordance with instructions from the controller 23. This makes it possible to reduce unnecessary consumption of the small amount of power supplied to the water flood detection device 2.

The water flood detection device 2 includes the water flood detection module 30 that can be installed at a location separate from the main body 20. The water flood detection module 30 includes the water flood detection sensor 31 that detects water flooding. The water flood detection sensor 31 and the main body 20 of the water flood detection device 2 are electrically connected via a signal line and a power line.

FIG. 2 is a diagram illustrating one example of an installation location of the water flood detection device 2 according to the present embodiment. In the illustrated example, the main body 20 of the water flood detection device 2 is placed within a closure 51 installed, for example, in a manhole 50 (underground facility), and the water flood detection module 30 is installed within the manhole 50, protruding outside the closure 51.

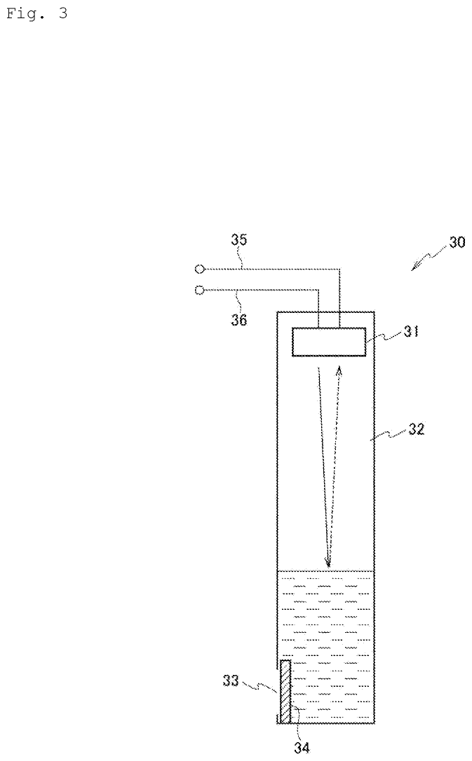

FIG. 3 is a diagram illustrating a configuration of the water flood detection module 30 according to the present embodiment.

The illustrated water flood detection module 30 includes a water flood detection sensor 31 and a water flood tank 32. The water flood detection sensor 31 operates using power from the power storage unit 24 under the control of the controller 23, and detects water flooding in the manhole 50. The water flood detection sensor 31 is connected to the water flood detection device 2 by a signal line 35 for driving the water flooding detection sensor 31 and a power line 36.

The water flood tank 32 has a water flood port 33 into which water that has entered the manhole 50 flows. Accordingly, the water that has entered the manhole 50 flows into the water flood tank 32, and a water level therein becomes equal to a water level in the manhole 50. In other words, if the water level in the water flood tank 32 is known, the water level in the manhole 50 can be detected.

The water flood detection sensor 31 can be a water flood detection sensor capable of measuring the water level, such as an infrared water level sensor that is easily available. The water flood detection sensor 31 of the present embodiment can measure a distance to a water surface in the water flood tank 32, and detect whether or not the manhole 50 is flooded and the water level in the manhole 50 based on the measured distance. In this case, the water flood detection sensor 31 outputs whether water flooding is present and the water level in the manhole 50 as the detection information to the controller 23 via the signal line 35.

In addition, the water flood detection sensor 31 may measure the distance to the water surface in the water flood tank 32 and output the measured distance to the controller 23, and the controller 23 may calculate the water level of the water that has entered the manhole 50 based on the distance measured by the water flood detection sensor 31 and output the water level to the control device 1 as the detection information.

The water flood port 33 may be provided with a filter 34 that prevents things other than water (such as dead leaves and garbage) from entering the water flood tank 32. By providing the filter 34 in the water flood tank 32, water flood detection in the manhole 50 can be repeatedly performed without the wastewater mixed with garbage inside the manhole 50 coming into direct contact with the water flood detection sensor 31.

Next, operations of the water flood detection system according to the present embodiment will be described.

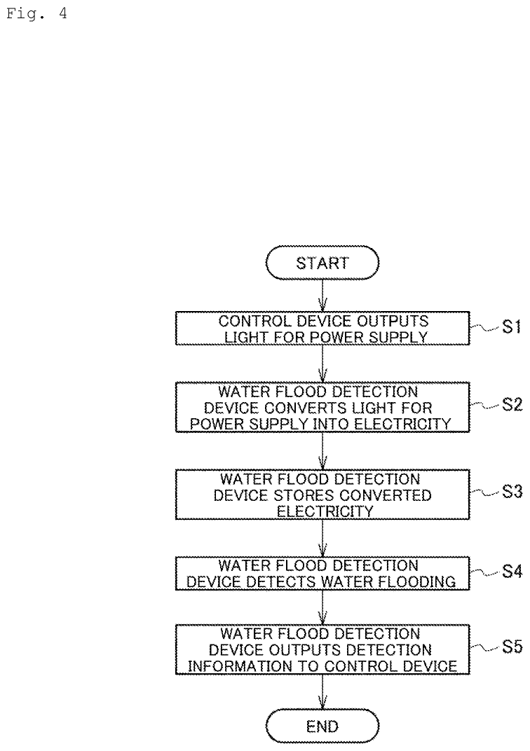

FIG. 4 is a flowchart illustrating operations of the water flood detection system according to the present embodiment. The control device 1 outputs the light for power supply onto which the control signal is superimposed to the water flood detection device 2 via the optical fiber 4 (S11). The photoelectric conversion unit 21 of the water flood detection device 2 converts the light output from the control device 1 into electricity (S12) and stores the converted electricity in the power storage unit 24 (S13). The water flood detection sensor 31 of the water flood detection device 2 operates using power from the power storage unit 24 under the control of the controller 23, and detects water flooding in the manhole 50 (S14). The upstream communication mechanism 22 of the water flood detection device 2 generates the optical signal including the detection information detected by the water flood detection sensor 31 under the control of the controller 23, and outputs it to the control device 1 via the optical fiber 4 (S15).

### Embodiment 2

In the water flood detection system of the present embodiment, a plurality of water flood detection devices are operated by a light source of a single control device.

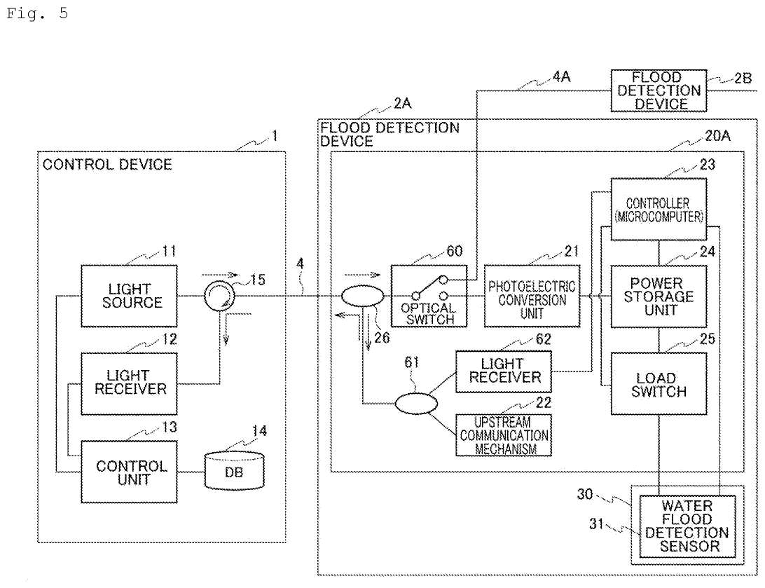

FIG. 5 is a diagram illustrating a configuration of a water flood detection system according to the present embodiment. The water flood detection system according to the present embodiment includes a control device 1 and water flood detection devices 2A and 2B. A plurality of water flood detection devices 2A and 2B are connected in series via an optical fiber 4A. The control device 1 of the present embodiment is similar to the control device 1 of Embodiment 1.

The water flood detection device 2A differs from the water flood detection device 2 of Embodiment 1 in that it is equipped with an optical switch 60, an optical coupler 61, and a light receiver 62. The optical coupler 26 (first optical coupler) of the present embodiment branches the light output from the control device 1 into two light beams.

The optical switch 60 switches one of the light beams branched off from the optical coupler 26 to itself or to another device. Specifically, the optical switch 60 is provided directly below the optical coupler 26, and switches whether the downstream light branched off from the optical coupler 26 is guided to its own photoelectric conversion unit 21, or to the water flood detection device 2B installed further downstream. The controller 23 in the present embodiment further has a function of controlling the optical switch 60.

The optical coupler 61 (second optical coupler) branches the other light beam branched from optical coupler 26. The light receiver 62 receives one of the light beams branched from the optical coupler 61 as a signal. A light receiving element such as a photodiode is used for the light receiver 62. Specifically, the optical coupler 61 further branches the light beam branched by optical coupler 26 so that it can receive a control signal from the control device 1 regardless of the switching state of the optical switch 60. The light beam branched by the optical coupler 61 is guided to the light receiver 62, which receives the light as a control signal, and to the upstream communication mechanism 22, which generates an upstream optical signal. Consequently, even if the optical switch 60 is switched to the water flood detection device 2B downstream of itself, it is possible to receive the optical signal that is the control signal for its own water flood detection device 2A.

The upstream communication mechanism 22 modulates the other light beam branched by the optical coupler 61 based on, for example, detection information to generate modulated light, and outputs the modulated light to the control device 1. The upstream communication mechanism 22 may modulate the other light beam based on voltage information of the power storage unit 24 to generate modulated light, and output the modulated light to the control device 1.

The water flood detection device 2B is connected in series to the water flood detection device 2A via the optical fiber 4A. A configuration of the water flood detection device 2B is similar to that of the water flood detection device 2A.

While FIG. 5 illustrates two water flood detection devices 2A and 2B, three or more water flood detection devices may be connected to the control device 1. That is, another water flood detection device (not shown) may be connected further downstream of the water flood detection device 2B. In the present embodiment, one control device 1 can control the plurality of water flood detection devices 2A and 2B, making it easy to detect water flooding in a large number of manholes 50.

### Effects

As described in Embodiments 1 and 2 above, in the water flood detection system of the present embodiment, the control device 1 supplies power and the control signal to the downstream water flood detection device 2 using the optical fiber 4. The water flood detection device 2 stores power in the power storage unit 24, and when necessary, uses the power from the power storage unit 24 to drive the water flood detection sensor 31 to detect water flooding in the manhole 50, and outputs the detection information to the control device 1 via the upstream communication mechanism 22. In this way, water flooding in the manhole 50 can be repeatedly detected in the present embodiment.

Furthermore, if a water flood detection sensor capable of measuring water level (such as an infrared water level sensor) is used as the water flood detection sensor 31, the water flood detection sensor 31 can measure the distance to the water surface in the water flood tank 32 and detect the water level in the water flood tank 32 (i.e. the manhole 50) based on the measured distance. In this case, the water flood detection device 2 outputs the water level in the water flood tank 32 measured by the water flood detection sensor 31 to the control device 1 as the detection information. This makes it possible for the control device 1 to find out the water level in the manhole 50. Therefore, the control device 1 can identify the detailed water level inside the manhole 50 as it becomes flooded, making it possible to plan necessary measures in advance.

Furthermore, by placing the water flood detection module 30 outside the closure 51, it is possible to find out the water flooding of the manhole 50. Moreover, by using an electrically operated water flood detection sensor 31, water flood detection can be carried out repeatedly.

Further, by employing the water flood tank 32 equipped with the filter 34 in the water flood detection module 30, it is possible to protect the water flood detection sensor 31 from debris, thereby extending the lifespan of the water flood detection sensor 31.

The control unit 13 of the control device 1 and the controller 23 of the water flood detection device 2 described above can be, for example, a general-purpose computer system. The computer system includes a central processing unit (CPU, processor), a memory, a storage (hard disk drive (HDD), solid state drive (SSD)), a communication device, an input device 905, and an output device. The memory and the storage are storage devices. In this computer system, the functions of the control unit 13 or the controller 23 are implemented by the CPU executing a predetermined program loaded on the memory. A program of the control unit 13 or the controller 23 can be stored in a computer-readable recording media such as an HDD, an SSD, a universal serial bus (USB) memory, a compact disc (CD), and a digital versatile disc (DVD) or distributed over a network. The computer-readable recording medium is, for example, a non-transitory recording medium.

The present disclosure is not limited to the above embodiments, and modifications can be made within the scope and gist of the disclosure.

### REFERENCE SIGNS LIST

1 Control device
11 Light source
12 Light receiver
13 Control unit
14 Database
2 Water flood detection device
21 Photoelectric conversion unit
22 Upstream communication mechanism (communication mechanism)
23 Controller
24 Power storage unit
25 Load switch
3 Water flood detection module
31 Water flood detection sensor
32 Water flood tank
33 Water flood port
34 Filter
4 Optical fiber
50 Manhole (underground facility)

1. A water flood detection system, comprising:
a control device; and
a water flood detection device, wherein:
the control device includes a light source configured to output light to the water flood detection device via an optical fiber,
the water flood detection device includes:
a photoelectric conversion unit configured to convert the light into electricity;
a power storage unit configured to store the converted electricity; and
a water flood detection sensor configured to operate using electricity from the power storage unit to detect water flooding in an underground facility.

2. The water flood detection system according to claim 1, wherein the water flood detection device includes a communication mechanism configured to output detection information detected by the water flood detection sensor to the control device via the optical fiber.

3. The water flood detection system according to claim 1, wherein:
the water flood detection device further includes a water flood tank into which water that has entered the underground facility flows and of which a water level becomes equal to a water level of the underground facility, and
the water flood detection sensor is configured to measure a distance to a water surface of the water flood tank and detects water flooding of the underground facility based on the distance.

4. The water flood detection system according to claim 3, wherein the water flood tank includes a filter configured to prevent entry of anything other than water.

5. The water flood detection system according to claim 1, wherein the water flood detection device includes a load switch configured to control supply of power from the power storage unit to the water flood detection sensor.

6. The water flood detection system according to claim 2, wherein the water flood detection device includes:
a first optical coupler configured to branch the light output from the control device into two light beams;
an optical switch configured to switch one of the light beams branched by the first optical coupler to the device itself or another device;
a second optical coupler configured to branch the other light beam branched by the first optical coupler; and
a photodiode configured to receive one of the light beams branched by the second optical coupler as a signal, and
the communication mechanism is configured to modulate the other light beam branched by the second optical coupler based on the detection information to generate modulated light, and output the modulated light to the control device.

7. A water flood detection device, comprising:
a photoelectric conversion unit configured to convert light into electricity, the light being output from a control device via an optical fiber;
a power storage unit configured to store the converted electricity; and
a water flood detection sensor configured to operate using electricity from the power storage unit to detect water flooding in an underground facility.

8. A water flood detection method executed by a control device and a water flood detection device, wherein the control device outputs light to the water flood detection device via an optical fiber, and
the water flood detection device converts the light into electricity, stores the converted electricity, and operates using the stored electricity to detect water flooding in an underground facility.
